(19) United States
(12) Patent Application Publication
(10) Pub. No.: US 2020/0140744 A1
(43) Pub. Date: May 7, 2020

(54) STIMULATING WELLS USING CO2, WATER BLOCK REMOVING AGENTS, AND/OR BREAKERS TO IMPROVE WELL PRODUCTION

(71) Applicant: Cudd Pressure Control, Inc., The Woodlands, TX (US)

(72) Inventors: Michael J. Gerstner, Midland, TX (US); George J. Lee, Midland, TX (US)

(73) Assignee: Cudd Pumping Services, Inc., The Woodlands, TX (US)

(21) Appl. No.: 16/654,444

(22) Filed: Oct. 16, 2019

Related U.S. Application Data
(60) Provisional application No. 62/746,291, filed on Oct. 16, 2018.
(60) Provisional application No. 62/806,260, filed on Feb. 15, 2019.

(51) Int. Cl. C09K 8/594; C09K 8/584; C09K 8/40; C09K 8/60; C09K 8/52; C09K 8/54; C09K 8/84; E21B 43/16

(52) U.S. Cl. CPC C09K 8/594; C09K 8/584; C09K 8/40; C09K 8/607; C09K 8/52; C09K 2208/24; C09K 8/605; C09K 8/845; E21B 43/164; C09K 2208/26; C09K 8/54

(57) ABSTRACT

In an embodiment, the present disclosure relates generally to a method for well stimulation. In some embodiments, the method includes pumping a treatment fluid into a well. In some embodiments, the treatment fluid includes carbon dioxide (CO₂) and a breaker, and the method further includes treating at least one of a reservoir and a wellbore of the well with the treatment fluid. In some embodiments, the breaker is a solution of stabilized chlorine dioxide (ClO₂). In some embodiments, the method further includes commingling the CO₂ with water and forming, as a result of the commingling, carbonic acid. In some embodiments, the method includes activating the stabilized ClO₂ to form activated ClO₂. In some embodiments, the activated ClO₂ is formed as a result of a lowering of pH in the treatment fluid by the carbonic acid.

### CROSS-REFERENCE TO RELATED APPLICATIONS

This patent application claims priority from, and incorporates by reference the entire disclosure of, U.S. Provisional Patent Application No. 62/746,291 filed on Oct. 16, 2018 and U.S. Provisional Patent Application No. 62/806,260 filed on Feb. 15, 2019.

### TECHNICAL FIELD

The present disclosure relates generally to stimulating wells and more particularly, but not by way of limitation, to stimulating wells using carbon dioxide (CO₂), water block removing agents, and/or breakers to improve well production.

### BACKGROUND

This section provides background information to facilitate a better understanding of the various aspects of the disclosure. It should be understood that the statements in this section of this document are to be read in this light, and not as admissions of prior art.

During the life of a well, various materials may be injected, or pumped, into the well to improve hydrocarbon production or extend the life of the well. For example, but not by way of limitation, water, clay control agents, fluid loss agents, friction reducers, gelling agents, crosslinkers, proppants, polymers, surfactants, scale-reducing agents, corrosion inhibitors, or combinations of the same and like may be injected, or pumped, into the well. In some instances, it may be desirable to stimulate the well after drilling to improve well productivity or, in the case of currently producing wells, to extend the life of the well or enhance existing production. Furthermore, in certain instances, in the life of the well, it is desirable to re-stimulate the well after previous stimulation operations, for example, after hydraulic fracturing, have occurred. In some instances, carbon dioxide (CO₂) can be utilized for well stimulation and re-stimulation.

### SUMMARY OF THE INVENTION

This summary is provided to introduce a selection of concepts that are further described below in the Detailed Description. This summary is not intended to identify key or essential features of the claimed subject matter, nor is it to be used as an aid in limiting the scope of the claimed subject matter.

In an embodiment, the present disclosure relates generally to a method for well stimulation. In some embodiments, the method includes pumping a treatment fluid into a well. In some embodiments, the treatment fluid includes carbon dioxide (CO₂) and a breaker, and the method further includes treating at least one of a reservoir and a wellbore of the well with the treatment fluid.

In some embodiments, the breaker can include, without limitation, guar breakers, friction reducer breakers, slickwater breakers, oxidative breakers, enzyme breakers, gel breakers, ammonium persulfate, polyacrylamide breakers, or combinations thereof. In some embodiments, the breaker is a solution. In some embodiments, the solution includes stabilized chlorine dioxide (ClO₂). In some embodiments, the solution has a concentration of 5% v/v of the stabilized ClO₂.

In some embodiments, the method further includes commingling the CO₂ with water and forming, as a result of the commingling, carbonic acid. In some embodiments, the method includes activating the stabilized ClO₂ to form activated ClO₂. In some embodiments, the activated ClO₂ is formed as a result of a lowering of pH in the treatment fluid by the carbonic acid. In some embodiments, the lowering of pH results in the treatment fluid having a pH between about 4 to about 5. In some embodiments, the activated ClO₂ is formed at a predetermined depth in the well based, at least in part, on a concentration of the CO₂ and the stabilized ClO₂ in the treatment fluid. In some embodiments, the breaker is in a range of about 20% to about 75% total volume of the treatment fluid.

In some embodiments, the method includes pumping a treated spacer into the well. In some embodiments, the treated spacers include a diverter agent to divert the treatment fluid to a particular zone of interest. In some embodiments, the treatment fluid further includes a water block removing agent that can include, without limitation, stimulation surfactants, ethoxylated surfactants, sulfonated surfactants, citrus terpenes, alcohols, ionic surfactants, nonionic surfactants, cationic surfactants, anionic surfactants, amphoteric surfactants, flow-back enhancers, emulsifiers, dispersants, oil-wetters, water-wetters, foamers, defoamers, or combinations thereof. In some embodiments, the water block removing agent is in a range of about 20% to about 75% total volume of the treatment fluid. In some embodiments, the CO₂ is in a range of about 20% to about 75% total volume of the treatment fluid.

In some embodiments, the method further includes shutting-in the well for a predetermined period of time and flowing back the well after the predetermined period of time. In some embodiments, the treating includes at least one of mobilizing hydrocarbons in the reservoir, freeing hydrocarbons in the reservoir, lowering surface tension of residual fluids in the reservoir, and removing damage caused by residual material from previous fluids introduced into the well. In some embodiments, the treatment fluid further includes at least one of clay control agents, surfactants, foaming agents, fluid loss additives, scale reducing agents, corrosion inhibitors, biocides, and pH control additives.

In an additional embodiment, the present disclosure pertains to a method for well stimulation. In some embodiments, the method includes pumping a treatment fluid into a well, where the treatment fluid includes CO₂, stabilized ClO₂, and a water block removing agent that includes, without limitation, stimulation surfactants, ethoxylated surfactants, sulfonated surfactants, citrus terpenes, alcohols, ionic surfactants, nonionic surfactants, cationic surfactants, anionic surfactants, amphoteric surfactants, flow-back enhancers, emulsifiers, dispersants, oil-wetters, water-wetters, foamers, defoamers, or combinations thereof. In some embodiments, the method also includes commingling the CO₂ with water, forming, as a result of the commingling, carbonic acid, lowering pH of the treatment fluid with the carbonic acid, activating the stabilized ClO₂ to form activated ClO₂, where the activating occurs at a predetermined depth based, at least in part, on a concentration of the CO₂ and the stabilized ClO₂ in the treatment fluid, and where the activated ClO₂ is formed due to a lowering of pH in the treatment fluid by the carbonic acid. In some embodiments, the method further includes treating at least one of a reservoir and a wellbore of the well with the treatment fluid.

### BRIEF DESCRIPTION OF THE DRAWINGS

A more complete understanding of the subject matter of the present disclosure may be obtained by reference to the following Detailed Description when taken in conjunction with the accompanying Drawings wherein:

FIG. 1 illustrates wellhead rate, pressure, slurry rate, and CO₂ rate during execution of a planned well treatment; and

FIG. 2 illustrates net bottom-hole pressure during the executed treatment.

### DETAILED DESCRIPTION

It is to be understood that the following disclosure provides many different embodiments, or examples, for implementing different features of various embodiments. Specific examples of components and arrangements are described below to simplify the disclosure. These are, of course, merely examples and are not intended to be limiting. The section headings used herein are for organizational purposes and are not to be construed as limiting the subject matter described.

In general, the present disclosure relates to well stimulation. Well stimulation generally refers to a well intervention process performed on an oil or gas well to increase, restore, or enhance the productivity of the well by improving the flow of hydrocarbons from the reservoir into the wellbore. In various instances, well stimulation can involve a method in which carbon dioxide (CO₂) is injected into the reservoir of the well to increase production by reducing hydrocarbon viscosity and improving miscible, or partially miscible, displacement of hydrocarbons into the wellbore. CO₂ stimulation can be used as a first stimulation operation or any subsequent stimulation operation (re-stimulation) on a well.

However, standard CO₂ injections can have limitations, such as, for example: (i) failing to lower surface tension of certain fluids in the reservoir that impede hydrocarbon flow into the wellbore (e.g. treatment fluids after hydraulic fracturing); and (ii) failing to remove damage caused by added materials in various fluids introduced into the reservoir (e.g. during hydraulic fracturing). In some instances, these fluids or materials are introduced into the reservoir as a result of drilling operations, completion operations, well stimulation operations, such as, for example, hydraulic fracturing or acidizing, well intervention operations, such as, for example, fishing, milling, remedial work, or fluid swaps, and combinations of the same and like.

In instances where a well is subjected to hydraulic fracturing, treatment fluids are pumped at a high pressure and high rate into a zone, or area of interest, of the reservoir to be treated, causing a fracture to form in the formation of the rock matrix within the zone. Typically, the fractures extend away from the wellbore in opposing directions according to the natural stresses within the formation. During hydraulic fracturing, proppant (e.g. sand) is mixed with the treatment fluids to keep the fracture open when the hydraulic fracturing is completed and the pressure acting against the formation has subsided. While hydraulic fracturing creates high-conductivity communication with a large area of the formation, during the life of the well, the formation may need to undergo re-stimulation, and in these instances, CO₂ stimulations (e.g. CO₂ injections) can be utilized as re-stimulation efforts.

However, once hydraulic fracturing has occurred in a particular well, conventional CO₂ stimulations become less productive as the formation has been exposed to various treatment, or fracturing, fluids and materials contained therein. As discussed above, standard CO₂ injections have limitations, and these limitations are often exacerbated by the use of treatment fluids used in hydraulic fracturing. For example, in standard re-stimulation of a well, conventional CO₂ stimulations fail to lower the surface tension of the treatment fluids left in the reservoir (e.g. guar-based gels), and additionally, fail to remove damage caused by added materials (e.g. friction reducers) in the treatment fluids.

As such, in view of the foregoing, an embodiment of the present disclosure relates generally to a stimulation method utilizing CO₂ to stimulate a well. In some embodiments, the stimulation method utilizes CO₂ and water to stimulate the well. In some embodiments, the stimulation method further utilizes a water block removing agent to stimulate the well. In some embodiments, the stimulation method further utilizes a breaker to stimulate the well. In some embodiments, the stimulation method utilizes a combination of one or more of the CO₂, the water, the water block removing agent, and the breaker to stimulate the well.

Furthermore, an additional embodiment of the present disclosure relates to a treatment fluid including CO₂ for well stimulation. In some embodiments, the treatment fluid includes CO₂ and water for well stimulation. In some embodiments, the treatment fluid further includes a water block removing agent for well stimulation. In some embodiments, the treatment fluid further includes a breaker for well stimulation. In some embodiments, the treatment fluid includes a combination of one or more of the CO₂, the water, the water block removing agent, and the breaker for well stimulation.

In some embodiments, the CO₂ can be in a range of about 20% to about 75% total volume of fluid. In some embodiments, the water block removing agent can be in a range of about 0% to about 75% total volume of fluid. In some embodiments, the breaker can be in a range of about 0% to about 75% total volume of fluid. In some embodiments, the water block removing agent can be in a range of about 20% to about 75% total volume of fluid. In some embodiments, the breaker can be in a range of about 20% to about 75% total volume of fluid.

In some embodiments, the well can be a hydrocarbon well. In some embodiments, the well can be a gas well. In some embodiments, the well can be an oil well. In some embodiments, the well can be a vertical well. In some embodiments, the well can be a horizontal well. In some embodiments, the well formation can be oil forming, natural gas forming, or combinations thereof. In some embodiments, the well can have a shale formation that can include, without limitation, Bakken shale formation, Barnett shale formation, Eagle Ford shale formation, Fayetteville shale formation, Haynesville shale formation, Marcellus shale formation, Niobrara shale formation, Permian Basin shale formation, Utica shale formation, Wolfcamp shale formation, or Woodford shale formation. In some embodiments, the well can be an offshore or land based well. In some embodiments, the well can be a shallow, deep, or ultra-deep well.

In some embodiments, the water block removing agent can decrease interfacial tension and shift reservoir wettability. In some embodiments, the water block removing agent can a surfactant. In some embodiments, the water block removing agent can include, without limitation, stimulation surfactants, ethoxylated surfactants, sulfonated surfactants, citrus terpenes, alcohols, ionic surfactants, nonionic surfactants, cationic surfactants, anionic surfactants, amphoteric surfactants, flow-back enhancers, emulsifiers, dispersants, oil-wetters, water-wetters, foamers, defoamers, or combinations of the same and like.

In some embodiments, the breaker breaks down gels or other chemicals, scales, or corrosion within the reservoir or in the wellbore. In some embodiments, the breaker can include, without limitation, guar breakers, friction reducer breakers, slickwater breakers, oxidative breakers, enzyme breakers, gel breakers, ammonium persulfate, polyacrylamide breakers, or combinations of the same and like.

Chlorine dioxide (ClO₂) is a powerful and highly selective oxidizer that can be used, without limitation, to eliminate sulfide deposits, eliminate biofilm and polymer residues, neutralize hydrogen sulfide, and dissolve plugging agents, such as, but not limited to, iron sulfide and polymers. As such, in some embodiments, the breaker can be ClO₂. In some embodiments, the ClO₂ is a stabilized ClO₂. In some embodiments, the ClO₂ is a 5% v/v solution of stabilized ClO₂. In embodiments where the breaker is stabilized ClO₂, the combination of CO₂, water, and stabilized ClO₂ allows for the commingling of each constituent part in order to form activated ClO₂ downhole allowing for improved well stimulation by removing damage caused by added materials from various fluids introduced into the reservoir or wellbore. In some embodiments, generation of carbonic acid, as a result of mixing water and CO₂ during stimulation treatment, activates the stabilized ClO₂ downhole. In some embodiments, concentrations of the CO₂, the water, or the stabilized ClO₂ can allow for the activation of the stabilized ClO₂ at a particular depth. For example, the CO₂, the water, and the stabilized ClO₂ can have concentrations chosen such that the commingling forms carbonic acid in concentrations adequate to convert the stabilized ClO₂ to activated ClO₂ at a desired depth in the well.

In some embodiments, the stabilized ClO₂ becomes activated upon reduction in pH of the treatment fluid. For example, in some embodiments, the reduction in pH occurs in the treatment fluid when CO₂ commingles with water to form carbonic acid. In this example, the carbonic acid causes a decrease in pH of the treatment fluid. In this manner, the activation of the stabilized ClO₂ can be controlled by a treatment schedule created for the stimulation method. In some embodiments, the controlled activation can be utilized to allow for various activation percentages of the ClO₂ activated from the stabilized ClO₂. This allows for the controlled activation of the stabilized ClO₂ at a desired depth in the well. As such, based on wellbore conditions and a desired activation percent at a zone of interest, the treatment scheduled can be designed to allow for optimal activated ClO₂ to enter into formation. This type of controlled activation allows for the stabilized ClO₂ to be activated near, or at, the zone of interest. In this manner, the ClO₂ does not unnecessarily react with components in the wellbore before reaching the desired depth, as is typical with conventional stimulation methods utilizing breakers. This further allows for the control of percent-activated ClO₂ at desired depths. For instance, stabilized ClO₂ can be converted to 1 to 100% activated ClO₂ at any desired depth by controlling the CO₂, the water, and the stabilized ClO₂ concentrations.

In some embodiments, the pH range of the treatment fluid can be lowered to about 4 to about 5 in order to activate the stabilized ClO₂. In some embodiments, upon activation of the stabilized ClO₂, the ClO₂ forms dissolved, activated, ClO₂ solution that can be injected, or pumped, into the reservoir of the well. This downhole activation of stabilized ClO₂ is notable because ClO₂ is a true gas dissolved in water, and thus, will behave as a nano-fluid allowing it to permeate into the rock matrix in a unique manner. As such, activated ClO₂ downhole allows for better permeability compared to traditional breakers into the rock matrix of the reservoir than conventional CO₂ stimulation methods. This allows for the enhanced removal of damages caused by added materials, such as friction reducers or gels, introduced into the reservoir.

In some embodiments, the CO₂ utilized in stimulation methods can be in a range of about 20% to about 75% total volume of fluid. In some embodiments, the stabilized ClO₂ utilized in stimulation methods can be in a range of about 0% to about 75% total volume of fluid. In some embodiments, the water block removing agent utilized in stimulation methods can be in a range of about 0% to about 75% total volume of fluid. In some embodiments, the stabilized ClO₂ utilized in stimulation methods can be in a range of about 20% to about 75% total volume of fluid. In some embodiments, the water block removing agent utilized in stimulation methods can be in a range of about 20% to about 75% total volume of fluid.

In some embodiments, the activation of the stabilized ClO₂ can be delayed. In some embodiments, the activation of the stabilized ClO₂ can be immediate or near immediate, for example, in shallow wells or in wells in which near-surface areas needs to undergo a treatment to remove excess buildup of gels, friction reducing agents, sulfides, such as iron sulfide, polymers, scale, or combinations of the same and like.

In such embodiments where immediate or near immediate activation of the stabilized ClO₂ is desired, the stabilized ClO₂ can be combined with mineral acid to partially, or fully, activate the stabilized ClO₂ to 1% to 100% activated ClO₂. In some embodiments, the stabilized ClO₂ is combined with an organic acid to partially, or fully, activate the stabilized ClO₂ to 1% to 100% activated ClO₂.

In some embodiments, the mineral acid can include, without limitation, hydrochloric acid, nitric acid, phosphoric acid, sulfuric acid, boric acid, hydrofluoric acid, hydrobromic acid, perchloric acid, hydroiodic acid, or combinations of the same and like. In some embodiments, the organic acid can include, without limitation, lactic acid, acetic acid, formic acid, citric acid, oxalic acid, uric acid, malic acid, glyoxylic acid, glycolic acid, or combinations of the same and like.

In some embodiments, the breaker can be sodium chlorite (NaClO₂). In this particular embodiment, the combination of CO₂, water, and NaClO₂ allows for the commingling of each constituent part in order to form ClO₂ downhole allowing for improved well stimulation by removing damage caused by added materials in from various fluids introduced into the reservoir. In some embodiments, generation of carbonic acid, as a result of mixing water and CO₂ during stimulation treatment, converts the NaClO₂ to ClO₂ downhole in a similar manner to that of the conversion of stabilized ClO₂ to activated ClO₂ as described above.

In some embodiments, generation of carbonic acid, as a result of mixing water and CO₂ during stimulation treatment, converts the NaClO₂ to ClO₂ downhole. In some embodiments, concentrations of the CO₂, the water, or the NaClO₂ can allow for the conversion of the NaClO₂ to ClO₂ at a particular depth. For example, the CO₂, the water, and the NaClO₂ can have concentrations chosen such that the commingling forms carbonic acid in concentrations adequate to convert the NaClO₂ to ClO₂ at a desired depth in the well.

In some embodiments, the NaClO₂ converts to ClO₂ upon reduction in pH of the treatment fluid. For example, in some embodiments, the reduction in pH occurs in the treatment fluid when CO₂ commingles with water to form carbonic acid. In this example, the carbonic acid causes a decrease in pH of the treatment fluid. In this manner, the conversion of NaClO₂ to ClO₂ can be controlled by a treatment schedule created for the stimulation method. In some embodiments, the controlled conversion can be utilized to allow for various percentages of the ClO₂ to be converted from the NaClO₂. This allows for the controlled conversion of the NaClO₂ at a desired depth in the well. As such, based on wellbore conditions and a desired ClO₂ amounts at a zone of interest, the treatment scheduled can be designed to allow for optimal ClO₂ to enter into formation. This type of controlled activation allows for the NaClO₂ to be converted near, or at, the zone of interest to ClO₂. In this manner, the ClO₂ does not unnecessarily react with components in the wellbore before reaching the desired depth, as is typical with conventional stimulation methods using breakers. This further allows for the control of percentage of the ClO₂ at desired depths. For instance, NaClO₂ can be converted to 1% to 100% ClO₂ at any desired depth by controlling the CO₂, the water, and the NaClO₂ concentrations.

The downhole generation of ClO₂, similar to the activation of ClO₂ from stabilized ClO₂, is notable as well, as ClO₂ is a true gas dissolved in water, and thus, will behave as a nano-fluid allowing it to permeate into the rock matrix in a unique manner similar to that of ClO₂ activated from stabilized ClO₂. As such, the addition of NaClO₂ to form ClO₂ downhole allows for better permeability of a breaker into the rock matrix of the reservoir than conventional CO₂ stimulation methods. This allows for the enhanced removal of damages caused by added materials, such as friction reducers or gels, introduced into the reservoir.

In some embodiments, the CO₂ utilized in stimulation methods can be in a range of about 20% to about 75% total volume of fluid. In some embodiments, the NaClO₂ utilized in stimulation methods can be in a range of about 0% to about 75% total volume of fluid. In some embodiments, the water block removing agent utilized in stimulation methods can be in a range of about 0% to about 75% total volume of fluid. In some embodiments, the NaClO₂ utilized in stimulation methods can be in a range of about 20% to about 75% total volume of fluid. In some embodiments, the water block removing agent utilized in stimulation methods can be in a range of about 20% to about 75% total volume of fluid.

In some embodiments, the NaClO₂ is a partially activated NaClO₂. In some embodiments, the NaClO₂ is combined with mineral acid, such as those described above, to partially activate the NaClO₂ to 1% to 100% ClO₂. In some embodiments, the NaClO₂ is combined with an organic acid, such as those described above, to partially activate the NaClO₂ to 1% to 100% ClO₂. In some embodiments, the stimulation method utilizing a combination of CO₂, water, and NaClO₂ can further include a buffering system, for example, but not limited to, a combination of pH buffers, to allow for a smooth and controlled reaction for conversion of NaClO₂ to ClO₂.

In some embodiments, the stimulation methods and compositions disclosed herein can further include, without limitation, clay control agents, surfactants, foaming agents, fluid loss additives, scale reducing agents, corrosion inhibitors, biocides, pH control additives, or combinations of the same and like.

In a particular embodiment, the stimulation method can include injecting, or pumping, a treatment fluid including CO₂, water, for example, fresh water, a water block removing agent, and a breaker into the formation of a well thereby improving hydrocarbon production. In some embodiments, the water block removing agent can be the water block removing agent as discussed above. In some embodiments, the breaker can be the breaker as discussed above. In some embodiments, the breaker can be stabilized ClO₂. In some embodiments, the breaker can be NaClO₂. In some embodiments, diverters can be utilized during the injection process to direct the treatment fluid to a particular zone, or area, of interest in the well. In these embodiments, diverters can, for example, isolate perforation zones of interest in the well such that the treatment fluid bypasses other perforation zones.

In some embodiments, the diverters can include, without limitation, degradable ball plugs, biodegradable ball plugs, ball plugs, frac plugs, composite plugs, bridge plugs, drillable plugs, drillable composite plugs, drillable frac plugs, or combinations of the same and like. In some embodiments, the diverters can be a part of the treatment fluid. In some embodiments, the diverters can be added on an intermittent basis to the treatment fluid, for example, during certain intervals of a treatment schedule, as illustrated below. In certain embodiments, such as those with drillable plugs, diverters can be added before the stimulation method in order to isolate a zone of interest.

In some embodiments, a buffering system, for example, but not limited to, a combination of pH buffers, can be utilized in the stimulation method in order to allow for a smooth and controlled reaction of NaClO₂ to ClO₂ in embodiments where the breaker is NaClO₂. In some embodiment, the well undergoing the treatment method disclosed herein may be subsequently shut-in for an extended, predetermined, period of time to maximize the benefits of the treatment fluid on the formation. In some embodiments, after shut-in, the well can then be flown back and placed back into production.

In some embodiments, the CO₂, the water, the water block removing agent, and the breaker can be injected, or pumped, into the well together. In some embodiments, the CO₂, the water, the water block removing agent, and the breaker can be each, individually, be injected, or pumped, at different stages of the stimulation treatment. In some embodiments, the CO₂, the water, the ClO₂, and the water block removing agent can be injected, or pumped, into the well together. In some embodiments, the CO₂, the water, the ClO₂, and the water block removing agent can be each, individually, injected, or pumped, at different stages of the stimulation treatment. In embodiments where a mineral acid or an organic acid is utilized to partially, or fully, activate or convert the ClO₂, the mineral acid or the organic acid can be injected, or pumped, into the well with the treatment fluid or be injected, or pumped, at different stages of the stimulation treatment.

In some embodiments, the CO₂, the water, the NaClO₂, and the water block removing can be injected, or pumped, into the well together. In some embodiments, the CO₂, the water, the NaClO₂, and the water block removing agent can be each, individually, be injected, or pumped, at different stages of the stimulation treatment. In embodiments where a mineral acid or an organic acid is utilized to partially, or fully, convert the NaClO₂, the mineral acid or the organic acid can be injected, or pumped, into the well with the treatment fluid or be injected, or pumped, at different stages of the stimulation treatment.

As illustrated in the non-limiting example provided herein below, in some embodiments, breakers can be injected, or pumped, into the well during various stages of the stimulation treatment. Moreover, in some embodiments, water block removing agents can be periodically injected, or pumped, into the well during various stages of the stimulation treatment. Furthermore, in some embodiments, diverters can be periodically injected, or pumped, during various stages of the stimulation treatment. In some embodiments, CO₂ can also be injected, or pumped, together with at least one of the breakers, the water block removing agents, and the diverters. Additionally, in some embodiments, additional breakers, such as, for example, ammonium persulfate, and additional water block removing agents can also be injected, or pumped, into the well during various stages of the stimulation treatment.

Without being bound by theory, it is believed the CO₂ will disperse throughout the formation and mobilize hydrocarbons in the reservoir, thereby freeing the hydrocarbons to be able to flow into the wellbore. In addition, the water block removing agents lower the surface tension of residual treatment, or fracturing, fluids, thereby removing them from being an impediment for hydrocarbons to flow into the wellbore. Moreover, the various breakers remove any damage caused by residuals from adding materials to the treatment, or fracturing, fluids during a previous hydraulic fracturing operation.

### Working Examples

Reference will now be made to more specific embodiments of the present disclosure and data that provides support for such embodiments. However, it should be noted that the disclosure below is for illustrative purposes only and is not intended to limit the scope of the claimed subject matter in any way.

Below illustrates a planned treatment schedule utilizing an embodiment of the stimulation methods and compositions, as presented above. The illustrative example below was planned for a well with a measured depth of approximately 18,080 ft, with perforations ranging from a measured depth of 11,890 ft (10,520 ft true vertical depth) to 17,981 ft (10,520 ft true vertical depth). The well had a bottom-hole fracture pressure of 8,942 psi having a 0.850 psi/ft fracture gradient (Wolfcamp formation), and a reservoir temperature of approximated 160° F. with an estimated surface temperature of 80° F. Treatment injection were to be conducted through 7 in outer diameter 26.0 lbs/ft casing (6.276 in inner diameter) from 0 to 9,717 ft, following 4 in outer diameter 11.6 lbs/ft casing (3.428 in inner diameter) to 18,080 ft. The perforation count was 612 having approximate hole sizes of about 0.410 in.

Table 1, shown below, illustrates the planned treatment schedule of the well. As can be seen below, after pumping rate is established with treated water, ClO₂ treatment and treated spacers are to be alternately pumped at approximately 30 bpm. After each ClO₂ treatment, diverters are to be injected into the well via treated spacers to force treatment fluid to the next zone, with the exception of the last ClO₂ treatment, in which the well is to be flushed with CO₂. A total of 17 stages are to be conducted over the span of 132.7 min via a treatment of 69 steps.

TABLE 1

| | | | Cln. | Cln. | Ttl. | Stg. | Cum. | Time |
|---|---|---|---|---|---|---|---|---|
| | | | Vol. | Vol. | Rate | Time | Time | Remaining |
| Step # | Fluid | Stage Type | (bbls) | (gals) | (bpm) | (mins) | (mins) | (mins) |
| 1 | Treated Water | Establish | 119.0 | 5,000 | 30.0 | 4.0 | 4.0 | 132.7 |
| | | Rate | | | | | | |
| 2 | ClO₂ Treatment | Stage 1 | 95.2 | 4,000 | 30.0 | 3.2 | 7.1 | 128.8 |
| 3 | Treated Spacer | Drop 18 | 6.0 | 250 | 30.0 | 0.2 | 7.3 | 125.6 |
| | | Diverters | | | | | | |
| 4 | ClO₂ Treatment | | 95.2 | 4,000 | 30.0 | 3.2 | 10.5 | 125.4 |
| 5 | Treated Spacer | Drop 18 | 6.0 | 250 | 30.0 | 0.2 | 10.7 | 122.2 |
| | | Diverters | | | | | | |
| 6 | ClO₂ Treatment | Stage 2 | 83.3 | 3,500 | 30.0 | 2.8 | 13.5 | 122.0 |
| 7 | Treated Spacer | Drop 18 | 6.0 | 250 | 30.0 | 0.2 | 13.7 | 119.2 |
| | | Diverters | | | | | | |
| 8 | ClO₂ Treatment | | 83.3 | 3,500 | 30.0 | 2.8 | 16.5 | 119.0 |
| 9 | Treated Spacer | Drop 18 | 6.0 | 250 | 30.0 | 0.2 | 16.7 | 116.3 |
| | | Diverters | | | | | | |
| 10 | ClO₂ Treatment | Stage 3 | 83.3 | 3,500 | 30.0 | 2.8 | 19.4 | 116.1 |
| 11 | Treated Spacer | Drop 18 | 6.0 | 250 | 30.0 | 0.2 | 19.6 | 113.3 |
| | | Diverters | | | | | | |
| 12 | ClO₂ Treatment | | 83.3 | 3,500 | 30.0 | 2.8 | 22.4 | 113.1 |
| 13 | Treated Spacer | Drop 18 | 6.0 | 250 | 30.0 | 0.2 | 22.6 | 110.3 |
| | | Diverters | | | | | | |
| 14 | ClO₂ Treatment | Stage 4 | 83.3 | 3,500 | 30.0 | 2.8 | 25.4 | 110.1 |
| 15 | Treated Spacer | Drop 18 | 6.0 | 250 | 30.0 | 0.2 | 25.6 | 107.3 |
| | | Diverters | | | | | | |
| 16 | ClO₂ Treatment | | 83.3 | 3,500 | 30.0 | 2.8 | 28.4 | 107.1 |
| 17 | Treated Spacer | Drop 18 | 6.0 | 250 | 30.0 | 0.2 | 28.6 | 104.4 |
| | | Diverters | | | | | | |
| 18 | ClO₂ Treatment | Stage 5 | 83.3 | 3,500 | 30.0 | 2.8 | 31.3 | 104.2 |
| 19 | Treated Spacer | Drop 18 | 6.0 | 250 | 30.0 | 0.2 | 31.5 | 101.4 |
| | | Diverters | | | | | | |
| 20 | ClO₂ Treatment | | 83.3 | 3,500 | 30.0 | 2.8 | 34.3 | 101.2 |
| 21 | Treated Spacer | Drop 18 | 6.0 | 250 | 30.0 | 0.2 | 34.5 | 98.4 |
| | | Diverters | | | | | | |
| 22 | ClO₂ Treatment | Stage 6 | 95.2 | 4,000 | 30.0 | 3.2 | 37.7 | 98.2 |
| 23 | Treated Spacer | Drop 18 | 6.0 | 250 | 30.0 | 0.2 | 37.9 | 95.0 |
| | | Diverters | | | | | | |
| 24 | ClO₂ Treatment | | 95.2 | 4,000 | 30.0 | 3.2 | 41.1 | 94.8 |
| 25 | Treated Spacer | Drop 18 | 6.0 | 250 | 30.0 | 0.2 | 41.3 | 91.7 |
| | | Diverters | | | | | | |
| 26 | ClO₂ Treatment | Stage 7 | 95.2 | 4,000 | 30.0 | 3.2 | 44.4 | 91.5 |
| 27 | Treated Spacer | Drop 18 | 6.0 | 250 | 30.0 | 0.2 | 44.6 | 88.3 |
| | | Diverters | | | | | | |
| 28 | ClO₂ Treatment | | 95.2 | 4,000 | 30.0 | 3.2 | 47.8 | 88.1 |
| 29 | Treated Spacer | Drop 18 | 6.0 | 250 | 30.0 | 0.2 | 48.0 | 84.9 |
| | | Diverters | | | | | | |
| 30 | ClO₂ Treatment | Stage 8 | 95.2 | 4,000 | 30.0 | 3.2 | 51.2 | 84.7 |
| 31 | Treated Spacer | Drop 18 | 6.0 | 250 | 30.0 | 0.2 | 51.4 | 81.5 |
| | | Diverters | | | | | | |
| 32 | ClO₂ Treatment | | 95.2 | 4,000 | 30.0 | 3.2 | 54.6 | 81.3 |
| 33 | Treated Spacer | Drop 18 | 6.0 | 250 | 30.0 | 0.2 | 54.8 | 78.2 |
| | | Diverters | | | | | | |
| 34 | ClO₂ Treatment | Stage 9 | 95.2 | 4,000 | 30.0 | 3.2 | 57.9 | 78.0 |
| 35 | Treated Spacer | Drop 18 | 6.0 | 250 | 30.0 | 0.2 | 58.1 | 74.8 |
| | | Diverters | | | | | | |
| 36 | ClO₂ Treatment | | 95.2 | 4,000 | 30.0 | 3.2 | 61.3 | 74.6 |
| 37 | Treated Spacer | Drop 18 | 6.0 | 250 | 30.0 | 0.2 | 61.5 | 71.4 |
| | | Diverters | | | | | | |
| 38 | ClO₂ Treatment | Stage 10 | 95.2 | 4,000 | 30.0 | 3.2 | 64.7 | 71.2 |
| 39 | Treated Spacer | Drop 18 | 6.0 | 250 | 30.0 | 0.2 | 64.9 | 68.1 |
| | | Diverters | | | | | | |
| 40 | ClO₂ Treatment | | 95.2 | 4,000 | 30.0 | 3.2 | 68.1 | 67.9 |
| 41 | Treated Spacer | Drop 18 | 6.0 | 250 | 30.0 | 0.2 | 68.3 | 64.7 |
| | | Diverters | | | | | | |
| 42 | ClO₂ Treatment | Stage 11 | 95.2 | 4,000 | 30.0 | 3.2 | 71.4 | 64.5 |
| 43 | Treated Spacer | Drop 18 | 6.0 | 250 | 30.0 | 0.2 | 71.6 | 61.3 |
| | | Diverters | | | | | | |
| 44 | ClO₂ Treatment | | 95.2 | 4,000 | 30.0 | 3.2 | 74.8 | 61.1 |
| 45 | Treated Spacer | Drop 18 | 6.0 | 250 | 30.0 | 0.2 | 75.0 | 57.9 |
| | | Diverters | | | | | | |
| 46 | ClO₂ Treatment | Stage 12 | 95.2 | 4,000 | 30.0 | 3.2 | 78.2 | 57.7 |
| 47 | Treated Spacer | Drop 18 | 6.0 | 250 | 30.0 | 0.2 | 78.4 | 54.6 |
| | | Diverters | | | | | | |
| 48 | ClO₂ Treatment | | 95.2 | 4,000 | 30.0 | 3.2 | 81.5 | 54.4 |
| 49 | Treated Spacer | Drop 18 | 6.0 | 250 | 30.0 | 0.2 | 81.7 | 51.2 |
| | | Diverters | | | | | | |
| 50 | ClO₂ Treatment | Stage 13 | 83.3 | 3,500 | 30.0 | 2.8 | 84.5 | 51.0 |
| 51 | Treated Spacer | Drop 18 | 6.0 | 250 | 30.0 | 0.2 | 84.7 | 48.2 |
| | | Diverters | | | | | | |
| 52 | ClO₂ Treatment | | 83.3 | 3,500 | 30.0 | 2.8 | 87.5 | 48.0 |
| 53 | Treated Spacer | Drop 18 | 6.0 | 250 | 30.0 | 0.2 | 87.7 | 45.2 |
| | | Diverters | | | | | | |
| 54 | ClO₂ Treatment | Stage 14 | 131.0 | 5,500 | 30.0 | 4.4 | 92.1 | 45.0 |
| 55 | Treated Spacer | Drop 18 | 6.0 | 250 | 30.0 | 0.2 | 92.3 | 40.7 |
| | | Diverters | | | | | | |
| 56 | ClO₂ Treatment | | 131.0 | 5,500 | 30.0 | 4.4 | 96.6 | 40.5 |
| 57 | Treated Spacer | Drop 18 | 6.0 | 250 | 30.0 | 0.2 | 96.8 | 36.1 |
| | | Diverters | | | | | | |
| 58 | ClO₂ Treatment | Stage 15 | 131.0 | 5,500 | 30.0 | 4.4 | 101.2 | 35.9 |
| 59 | Treated Spacer | Drop 18 | 6.0 | 250 | 30.0 | 0.2 | 101.4 | 31.5 |
| | | Diverters | | | | | | |
| 60 | ClO₂ Treatment | | 131.0 | 5,500 | 30.0 | 4.4 | 105.8 | 31.3 |
| 61 | Treated Spacer | Drop 18 | 6.0 | 250 | 30.0 | 0.2 | 106.0 | 27.0 |
| | | Diverters | | | | | | |
| 62 | ClO₂ Treatment | Stage 16 | 83.3 | 3,500 | 30.0 | 2.8 | 108.7 | 26.8 |
| 63 | Treated Spacer | Drop 18 | 6.0 | 250 | 30.0 | 0.2 | 108.9 | 24.0 |
| | | Diverters | | | | | | |
| 64 | ClO₂ Treatment | | 83.3 | 3,500 | 30.0 | 2.8 | 111.7 | 23.8 |
| 65 | Treated Spacer | Drop 18 | 6.0 | 250 | 30.0 | 0.2 | 111.9 | 21.0 |
| | | Diverters | | | | | | |
| 66 | ClO₂ Treatment | Stage 17 | 71.4 | 3,000 | 30.0 | 2.4 | 114.3 | 20.8 |
| 67 | Treated Spacer | Drop 18 | 6.0 | 250 | 30.0 | 0.2 | 114.5 | 18.5 |
| | | Diverters | | | | | | |
| 68 | ClO₂ Treatment | | 71.4 | 3,000 | 30.0 | 2.4 | 116.9 | 18.3 |
| 69 | CO₂ | Flush | 476.2 | 20,000 | 30.0 | 15.9 | 132.7 | 15.9 |

Table 2, shown below, illustrates a planned blender schedule for the stimulation of the well.

TABLE 2

| | Clean | Stg. | Cum. | Blender | Slurry | Stg. | Cum. | Stg. |
|---|---|---|---|---|---|---|---|---|
| | Rate | Clean. | Clean | Conc. | Rate | Slurry | Slurry | Time |
| Step # | (bpm) | (bbls) | (bbls) | (lb/gal) | (bpm) | (bbls) | (bbls) | (mins) |
| 1 | 15.00 | 59.5 | 59.5 | 0.00 | 15.00 | 59.5 | 59.5 | 4.0 |
| 2 | 15.00 | 47.6 | 107.1 | 0.00 | 15.00 | 47.6 | 107.1 | 3.2 |
| 3 | 15.00 | 3.0 | 110.1 | 0.00 | 15.00 | 3.0 | 110.1 | 0.2 |
| 4 | 15.00 | 47.6 | 157.7 | 0.00 | 15.00 | 47.6 | 157.7 | 3.2 |
| 5 | 15.00 | 3.0 | 160.7 | 0.00 | 15.00 | 3.0 | 160.7 | 0.2 |
| 6 | 15.00 | 41.7 | 202.4 | 0.00 | 15.00 | 41.7 | 202.4 | 2.8 |
| 7 | 15.00 | 3.0 | 205.4 | 0.00 | 15.00 | 3.0 | 205.4 | 0.2 |
| 8 | 15.00 | 41.7 | 247.0 | 0.00 | 15.00 | 41.7 | 247.0 | 2.8 |
| 9 | 15.00 | 3.0 | 250.0 | 0.00 | 15.00 | 3.0 | 250.0 | 0.2 |
| 10 | 15.00 | 41.7 | 291.7 | 0.00 | 15.00 | 41.7 | 291.7 | 2.8 |
| 11 | 15.00 | 3.0 | 294.6 | 0.00 | 15.00 | 3.0 | 294.6 | 0.2 |
| 12 | 15.00 | 41.7 | 336.3 | 0.00 | 15.00 | 41.7 | 336.3 | 2.8 |
| 13 | 15.00 | 3.0 | 339.3 | 0.00 | 15.00 | 3.0 | 339.3 | 0.2 |
| 14 | 15.00 | 41.7 | 381.0 | 0.00 | 15.00 | 41.7 | 381.0 | 2.8 |
| 15 | 15.00 | 3.0 | 383.9 | 0.00 | 15.00 | 3.0 | 383.9 | 0.2 |
| 16 | 15.00 | 41.7 | 425.6 | 0.00 | 15.00 | 41.7 | 425.6 | 2.8 |
| 17 | 15.00 | 3.0 | 428.6 | 0.00 | 15.00 | 3.0 | 428.6 | 0.2 |
| 18 | 15.00 | 41.7 | 470.2 | 0.00 | 15.00 | 41.7 | 470.2 | 2.8 |
| 19 | 15.00 | 3.0 | 473.2 | 0.00 | 15.00 | 3.0 | 473.2 | 0.2 |
| 20 | 15.00 | 41.7 | 514.9 | 0.00 | 15.00 | 41.7 | 514.9 | 2.8 |
| 21 | 15.00 | 3.0 | 517.9 | 0.00 | 15.00 | 3.0 | 517.9 | 0.2 |
| 22 | 15.00 | 47.6 | 565.5 | 0.00 | 15.00 | 47.6 | 565.5 | 3.2 |
| 23 | 15.00 | 3.0 | 568.5 | 0.00 | 15.00 | 3.0 | 568.5 | 0.2 |
| 24 | 15.00 | 47.6 | 616.1 | 0.00 | 15.00 | 47.6 | 616.1 | 3.2 |
| 25 | 15.00 | 3.0 | 619.0 | 0.00 | 15.00 | 3.0 | 619.0 | 0.2 |
| 26 | 15.00 | 47.6 | 666.7 | 0.00 | 15.00 | 47.6 | 666.7 | 3.2 |
| 27 | 15.00 | 3.0 | 669.6 | 0.00 | 15.00 | 3.0 | 669.6 | 0.2 |
| 28 | 15.00 | 47.6 | 717.3 | 0.00 | 15.00 | 47.6 | 717.3 | 3.2 |
| 29 | 15.00 | 3.0 | 720.2 | 0.00 | 15.00 | 3.0 | 720.2 | 0.2 |
| 30 | 15.00 | 47.6 | 767.9 | 0.00 | 15.00 | 47.6 | 767.9 | 3.2 |
| 31 | 15.00 | 3.0 | 770.8 | 0.00 | 15.00 | 3.0 | 770.8 | 0.2 |
| 32 | 15.00 | 47.6 | 818.5 | 0.00 | 15.00 | 47.6 | 818.5 | 3.2 |
| 33 | 15.00 | 3.0 | 821.4 | 0.00 | 15.00 | 3.0 | 821.4 | 0.2 |
| 34 | 15.00 | 47.6 | 869.0 | 0.00 | 15.00 | 47.6 | 869.0 | 3.2 |
| 35 | 15.00 | 3.0 | 872.0 | 0.00 | 15.00 | 3.0 | 872.0 | 0.2 |
| 36 | 15.00 | 47.6 | 919.6 | 0.00 | 15.00 | 47.6 | 919.6 | 3.2 |
| 37 | 15.00 | 3.0 | 922.6 | 0.00 | 15.00 | 3.0 | 922.6 | 0.2 |
| 38 | 15.00 | 47.6 | 970.2 | 0.00 | 15.00 | 47.6 | 970.2 | 3.2 |
| 39 | 15.00 | 3.0 | 973.2 | 0.00 | 15.00 | 3.0 | 973.2 | 0.2 |
| 40 | 15.00 | 47.6 | 1,020.8 | 0.00 | 15.00 | 47.6 | 1,020.8 | 3.2 |
| 41 | 15.00 | 3.0 | 1,023.8 | 0.00 | 15.00 | 3.0 | 1,023.8 | 0.2 |
| 42 | 15.00 | 47.6 | 1,071.4 | 0.00 | 15.00 | 47.6 | 1,071.4 | 3.2 |
| 43 | 15.00 | 3.0 | 1,074.4 | 0.00 | 15.00 | 3.0 | 1,074.4 | 0.2 |
| 44 | 15.00 | 47.6 | 1,122.0 | 0.00 | 15.00 | 47.6 | 1,122.0 | 3.2 |
| 45 | 15.00 | 3.0 | 1,125.0 | 0.00 | 15.00 | 3.0 | 1,125.0 | 0.2 |
| 46 | 15.00 | 47.6 | 1,172.6 | 0.00 | 15.00 | 47.6 | 1,172.6 | 3.2 |
| 47 | 15.00 | 3.0 | 1,175.6 | 0.00 | 15.00 | 3.0 | 1,175.6 | 0.2 |
| 48 | 15.00 | 47.6 | 1,223.2 | 0.00 | 15.00 | 47.6 | 1,223.2 | 3.2 |
| 49 | 15.00 | 3.0 | 1,226.2 | 0.00 | 15.00 | 3.0 | 1,226.2 | 0.2 |
| 50 | 15.00 | 41.7 | 1,267.9 | 0.00 | 15.00 | 41.7 | 1,267.9 | 2.8 |
| 51 | 15.00 | 3.0 | 1,270.8 | 0.00 | 15.00 | 3.0 | 1,270.8 | 0.2 |
| 52 | 15.00 | 41.7 | 1,312.5 | 0.00 | 15.00 | 41.7 | 1,312.5 | 2.8 |
| 53 | 15.00 | 3.0 | 1,315.5 | 0.00 | 15.00 | 3.0 | 1,315.5 | 0.2 |
| 54 | 15.00 | 65.5 | 1,381.0 | 0.00 | 15.00 | 65.5 | 1,381.0 | 4.4 |
| 55 | 15.00 | 3.0 | 1,383.9 | 0.00 | 15.00 | 3.0 | 1,383.9 | 0.2 |
| 56 | 15.00 | 65.5 | 1,449.4 | 0.00 | 15.00 | 65.5 | 1,449.4 | 4.4 |
| 57 | 15.00 | 3.0 | 1,452.4 | 0.00 | 15.00 | 3.0 | 1,452.4 | 0.2 |
| 58 | 15.00 | 65.5 | 1,517.9 | 0.00 | 15.00 | 65.5 | 1,517.9 | 4.4 |
| 59 | 15.00 | 3.0 | 1,520.8 | 0.00 | 15.00 | 3.0 | 1,520.8 | 0.2 |
| 60 | 15.00 | 65.5 | 1,586.3 | 0.00 | 15.00 | 65.5 | 1,586.3 | 4.4 |
| 61 | 15.00 | 3.0 | 1,589.3 | 0.00 | 15.00 | 3.0 | 1,589.3 | 0.2 |
| 62 | 15.00 | 41.7 | 1,631.0 | 0.00 | 15.00 | 41.7 | 1,631.0 | 2.8 |
| 63 | 15.00 | 3.0 | 1,633.9 | 0.00 | 15.00 | 3.0 | 1,633.9 | 0.2 |
| 64 | 15.00 | 41.7 | 1,675.6 | 0.00 | 15.00 | 41.7 | 1,675.6 | 2.8 |
| 65 | 15.00 | 3.0 | 1,678.6 | 0.00 | 15.00 | 3.0 | 1,678.6 | 0.2 |
| 66 | 15.00 | 35.7 | 1,714.3 | 0.00 | 15.00 | 35.7 | 1,714.3 | 2.4 |
| 67 | 15.00 | 3.0 | 1,717.3 | 0.00 | 15.00 | 3.0 | 1,717.3 | 0.2 |
| 68 | 15.00 | 35.7 | 1,753.0 | 0.00 | 15.00 | 35.7 | 1,753.0 | 2.4 |
| 69 | 0.00 | 0.0 | 1,753.0 | 0.00 | 0.00 | 0.0 | 1,753.0 | 15.9 |

Table 3, shown below, illustrates a planned CO₂ schedule for the stimulation of the well. During treatment, CO₂ is to be pumped at a rate of approximately 13.9 bpm at 50% CIP and approximately a 28.0 bpm foam rate.

TABLE 3

| | | CO₂ | Stg. CO₂ | Cum. CO₂ | Stg. CO₂ | Cum. CO₂ | Foam | Stg. | Cum. |
|---|---|---|---|---|---|---|---|---|---|
| | CO₂ % | Rate | Surface | Surface | Surface | Surface | Rate | Foam | Foam |
| Step # | (CIP) | (bpm) | (tons) | (tons) | (bbls) | (bbls) | (bpm) | (bbls) | (bbls) |
| 1 | 50 | 13.9 | 9.8 | 9.8 | 55.1 | 55.1 | 28.9 | 115 | 115 |
| 2 | 50 | 13.9 | 7.9 | 17.7 | 44.1 | 99.1 | 28.9 | 92 | 206 |
| 3 | 50 | 13.9 | 0.5 | 18.2 | 2.8 | 101.9 | 28.9 | 6 | 212 |
| 4 | 50 | 13.9 | 7.9 | 26.1 | 44.1 | 145.9 | 28.9 | 92 | 304 |
| 5 | 50 | 13.9 | 0.5 | 26.6 | 2.8 | 148.7 | 28.9 | 6 | 309 |
| 6 | 50 | 13.9 | 6.9 | 33.5 | 38.5 | 187.2 | 28.9 | 80 | 390 |
| 7 | 50 | 13.9 | 0.5 | 33.9 | 2.8 | 190.0 | 28.9 | 6 | 395 |
| 8 | 50 | 13.9 | 6.9 | 40.8 | 38.5 | 228.5 | 28.9 | 80 | 476 |
| 9 | 50 | 13.9 | 0.5 | 41.3 | 2.8 | 231.3 | 28.9 | 6 | 481 |
| 10 | 50 | 13.9 | 6.9 | 48.2 | 38.5 | 269.8 | 28.9 | 80 | 561 |
| 11 | 50 | 13.9 | 0.5 | 48.7 | 2.8 | 272.6 | 28.9 | 6 | 567 |
| 12 | 50 | 13.9 | 6.9 | 55.6 | 38.5 | 311.1 | 28.9 | 80 | 647 |
| 13 | 50 | 13.9 | 0.5 | 56.1 | 2.8 | 313.9 | 28.9 | 6 | 653 |
| 14 | 50 | 13.9 | 6.9 | 63.0 | 38.5 | 352.4 | 28.9 | 80 | 733 |
| 15 | 50 | 13.9 | 0.5 | 63.5 | 2.8 | 355.2 | 28.9 | 6 | 739 |
| 16 | 50 | 13.9 | 6.9 | 70.4 | 38.5 | 393.7 | 28.9 | 80 | 819 |
| 17 | 50 | 13.9 | 0.5 | 70.9 | 2.8 | 396.5 | 28.9 | 6 | 825 |
| 18 | 50 | 13.9 | 6.9 | 77.7 | 38.5 | 435.0 | 28.9 | 80 | 905 |
| 19 | 50 | 13.9 | 0.5 | 78.2 | 2.8 | 437.8 | 28.9 | 6 | 911 |
| 20 | 50 | 13.9 | 6.9 | 85.1 | 38.5 | 476.3 | 28.9 | 80 | 991 |
| 21 | 50 | 13.9 | 0.5 | 85.6 | 2.8 | 479.1 | 28.9 | 6 | 997 |
| 22 | 50 | 13.9 | 7.9 | 93.5 | 44.1 | 523.1 | 28.9 | 92 | 1,089 |
| 23 | 50 | 13.9 | 0.5 | 94.0 | 2.8 | 525.9 | 28.9 | 6 | 1,094 |
| 24 | 50 | 13.9 | 7.9 | 101.8 | 44.1 | 569.9 | 28.9 | 92 | 1,186 |
| 25 | 50 | 13.9 | 0.5 | 102.3 | 2.8 | 572.7 | 28.9 | 6 | 1,192 |
| 26 | 50 | 13.9 | 7.9 | 110.2 | 44.1 | 616.7 | 28.9 | 92 | 1,283 |
| 27 | 50 | 13.9 | 0.5 | 110.7 | 2.8 | 619.5 | 28.9 | 6 | 1,289 |
| 28 | 50 | 13.9 | 7.9 | 118.6 | 44.1 | 663.5 | 28.9 | 92 | 1,381 |
| 29 | 50 | 13.9 | 0.5 | 119.1 | 2.8 | 666.3 | 28.9 | 6 | 1,387 |
| 30 | 50 | 13.9 | 7.9 | 126.9 | 44.1 | 710.3 | 28.9 | 92 | 1,478 |
| 31 | 50 | 13.9 | 0.5 | 127.4 | 2.8 | 713.1 | 28.9 | 6 | 1,484 |
| 32 | 50 | 13.9 | 7.9 | 135.3 | 44.1 | 757.1 | 28.9 | 92 | 1,576 |
| 33 | 50 | 13.9 | 0.5 | 135.8 | 2.8 | 759.9 | 28.9 | 6 | 1,581 |
| 34 | 50 | 13.9 | 7.9 | 143.7 | 44.1 | 803.9 | 28.9 | 92 | 1,673 |
| 35 | 50 | 13.9 | 0.5 | 144.2 | 2.8 | 806.7 | 28.9 | 6 | 1,679 |
| 36 | 50 | 13.9 | 7.9 | 152.0 | 44.1 | 850.7 | 28.9 | 92 | 1,770 |
| 37 | 50 | 13.9 | 0.5 | 152.5 | 2.8 | 853.5 | 28.9 | 6 | 1,776 |
| 38 | 50 | 13.9 | 7.9 | 160.4 | 44.1 | 897.5 | 28.9 | 92 | 1,868 |
| 39 | 50 | 13.9 | 0.5 | 160.9 | 2.8 | 900.3 | 28.9 | 6 | 1,874 |
| 40 | 50 | 13.9 | 7.9 | 168.8 | 44.1 | 944.3 | 28.9 | 92 | 1,965 |
| 41 | 50 | 13.9 | 0.5 | 169.3 | 2.8 | 947.1 | 28.9 | 6 | 1,971 |
| 42 | 50 | 13.9 | 7.9 | 177.1 | 44.1 | 991.1 | 28.9 | 92 | 2,063 |
| 43 | 50 | 13.9 | 0.5 | 177.6 | 2.8 | 993.9 | 28.9 | 6 | 2,068 |
| 44 | 50 | 13.9 | 7.9 | 185.5 | 44.1 | 1,037.9 | 28.9 | 92 | 2,160 |
| 45 | 50 | 13.9 | 0.5 | 186.0 | 2.8 | 1,040.7 | 28.9 | 6 | 2,166 |
| 46 | 50 | 13.9 | 7.9 | 193.9 | 44.1 | 1,084.7 | 28.9 | 92 | 2,257 |
| 47 | 50 | 13.9 | 0.5 | 194.3 | 2.8 | 1,087.5 | 28.9 | 6 | 2,263 |
| 48 | 50 | 13.9 | 7.9 | 202.2 | 44.1 | 1,131.6 | 28.9 | 92 | 2,355 |
| 49 | 50 | 13.9 | 0.5 | 202.7 | 2.8 | 1,134.3 | 28.9 | 6 | 2,360 |
| 50 | 50 | 13.9 | 6.9 | 209.6 | 38.5 | 1,172.8 | 28.9 | 80 | 2,441 |
| 51 | 50 | 13.9 | 0.5 | 210.1 | 2.8 | 1,175.6 | 28.9 | 6 | 2,446 |
| 52 | 50 | 13.9 | 6.9 | 217.0 | 38.5 | 1,214.1 | 28.9 | 80 | 2,527 |
| 53 | 50 | 13.9 | 0.5 | 217.5 | 2.8 | 1,216.9 | 28.9 | 6 | 2,532 |
| 54 | 50 | 13.9 | 10.8 | 228.3 | 60.6 | 1,277.5 | 28.9 | 126 | 2,658 |
| 55 | 50 | 13.9 | 0.5 | 228.8 | 2.8 | 1,280.2 | 28.9 | 6 | 2,664 |
| 56 | 50 | 13.9 | 10.8 | 239.6 | 60.6 | 1,340.8 | 28.9 | 126 | 2,790 |
| 57 | 50 | 13.9 | 0.5 | 240.1 | 2.8 | 1,343.5 | 28.9 | 6 | 2,796 |
| 58 | 50 | 13.9 | 10.8 | 250.9 | 60.6 | 1,404.1 | 28.9 | 126 | 2,922 |
| 59 | 50 | 13.9 | 0.5 | 251.4 | 2.8 | 1,406.9 | 28.9 | 6 | 2,928 |
| 60 | 50 | 13.9 | 10.8 | 262.2 | 60.6 | 1,467.4 | 28.9 | 126 | 3,054 |
| 61 | 50 | 13.9 | 0.5 | 262.7 | 2.8 | 1,470.2 | 28.9 | 6 | 3,059 |
| 62 | 50 | 13.9 | 6.9 | 269.6 | 38.5 | 1,508.7 | 28.9 | 80 | 3,140 |
| 63 | 50 | 13.9 | 0.5 | 270.1 | 2.8 | 1,511.5 | 28.9 | 6 | 3,145 |
| 64 | 50 | 13.9 | 6.9 | 277.0 | 38.5 | 1,550.0 | 28.9 | 80 | 3,226 |
| 65 | 50 | 13.9 | 0.5 | 277.5 | 2.8 | 1,552.8 | 28.9 | 6 | 3,231 |
| 66 | 50 | 13.9 | 5.9 | 283.4 | 33.0 | 1,585.8 | 28.9 | 69 | 3,300 |
| 67 | 50 | 13.9 | 0.5 | 283.9 | 2.8 | 1,588.6 | 28.9 | 6 | 3,306 |
| 68 | 50 | 13.9 | 5.9 | 289.8 | 33.0 | 1,621.6 | 28.9 | 69 | 3,375 |
| 69 | 100 | 27.8 | 78.7 | 368.5 | 440.5 | 2,062.1 | 27.8 | 441 | 3,815 |

Table 4, shown below, illustrates planned cumulative treatment requirements for the stimulation of the well.

TABLE 4
Treatment Requirements (All Stages)
Fluids

| | |
|---|---|
| 67,000 | gals ClO₂ Treatment |

Additives per 1000 Gallons:

| | |
|---|---|
| 2.00 | gal Broad-Spectrum Demulsifier |
| 1,000.00 | gal Stabilized ClO₂ |
| 4.00 | gal Corrosion Inhibitor |
| 4,125 | gals Treated Spacer |

Additives per 1000 Gallons:

| | |
|---|---|
| 2.00 | gal Broad-Spectrum Demulsifier |
| 594.00 | each Diverting Agents |
| 2,500 | gals Treated Water |

Additives per 1000 Gallons:

| | |
|---|---|
| 2.00 | gal Broad-Spectrum Demulsifier |
| CO₂: | 368.5 tons |

Table 5, shown below, illustrates the planned pipe friction for the stimulation of the well.

TABLE 5

| ID | OD | ID | | Fric. | Fric. |
|---|---|---|---|---|---|
| Outer | Inner | Inner | Length | Gradient | PSI |
| 6.276 | 0.000 | 0.000 | 9,717 | 21.298 | 207 |
| 3.428 | 0.000 | 0.000 | 2,173 | 218.627 | 475 |

Table 6, shown below, illustrates the various planned parameters for the stimulation of the well.

TABLE 6

| | | | |
|---|---|---|---|
| Rate: | 30.00 | Perfs Top: | TVD: 10,520.00 |
| | | | MD: 11,890.00 |
| Perfs Bottom: | TVD: 10,520.00 | Frac Gradient: | 0.850 |
| | MD: 17,981.00 | | |
| Fluid Gradient: | 0.438 | BHFP: | 8,942 |
| Hit: | 4,606 | Total Perf | 0 |
| | | Friction Pressure: | |
| Total Restriction | 0 | Total Pipe | 682 |
| Friction Pressure: | | Friction Pressure: | |
| Surface Line | 0 | STP: | 5,018 |
| Friction | | Pressure: | |
| Hydraulic | 3,690 | Average Friction | 57.362 |
| Horsepower: | | Gradient: | |

Below illustrates an executed treatment log for the planned treatment schedule as presented above and executed on a well. Table 7, shown below, illustrates pressure testing performed prior to the execution of the planned treatment schedule.

TABLE 7

| | | | | | | | | Barrels/Linear |
|---|---|---|---|---|---|---|---|---|
| | Depth | OD | Weight | ID | | Volume | | Feet |
| Tubing 1 Length (ft): | | | | | | 0.00 | bbl | 0.00000 |
| Tubing 2 Length (ft): | | | | | | 0.00 | bbl | 0.00000 |
| Casing 1 Length (ft): | 9,717 | 7 | 26.00 | 6.276 | | 225.82 | bbl | 0.02324 |
| Casing 2 Length (ft): | 18,080 | 4 | 11.6 | 3.428 | | 0.00 | bbl | 0.00000 |
| Open Hole Length (ft): | | N/A | N/A | | | 0.00 | bbl | 0.00000 |
| Combined Depth (ft): | | | | | Annular Vol. | 236.40 | bbl | 0.00000 |

| | Depth | Vol. | | | |
|---|---|---|---|---|---|
| Top Perf/Open Hole: | 9,717 | | Maximum Pressure: | ISIP: | |
| Bottom Perf/Open Hole: | 18,080 | | Average Pressure: | 5 min: | N/A |
| Number of Perfs: | 612 | | Maximum Rate: | 10 min: | N/A |
| Perf Size: | 0.41 | | Average Rate: | 15 min: | N/A |
| Packer Depth: | N/A | | Fluid to Recover: | Proppant Total: | |

| STP | Net PSI | Rate | Stage | Total | Comments |
|---|---|---|---|---|---|
| — | | | | | Arrive on Location |
| — | | | | | Rig-Up Safety Meeting |
| — | | | | | Rig-Up Equipment |
| — | | | | | Test Lines |
| 4500 | | | | | Test Backside Pop-Off |
| — | | | | | Changing Rubber Seal in Iron |
| 9500 | | | | | Testing Lines |
| — | | | | | Leak on Iron |
| 9500 | | | | | Test Manuel Pop-Off |
| — | | | | | Turning Off Equipment |
| — | | | | | Leaving Location |

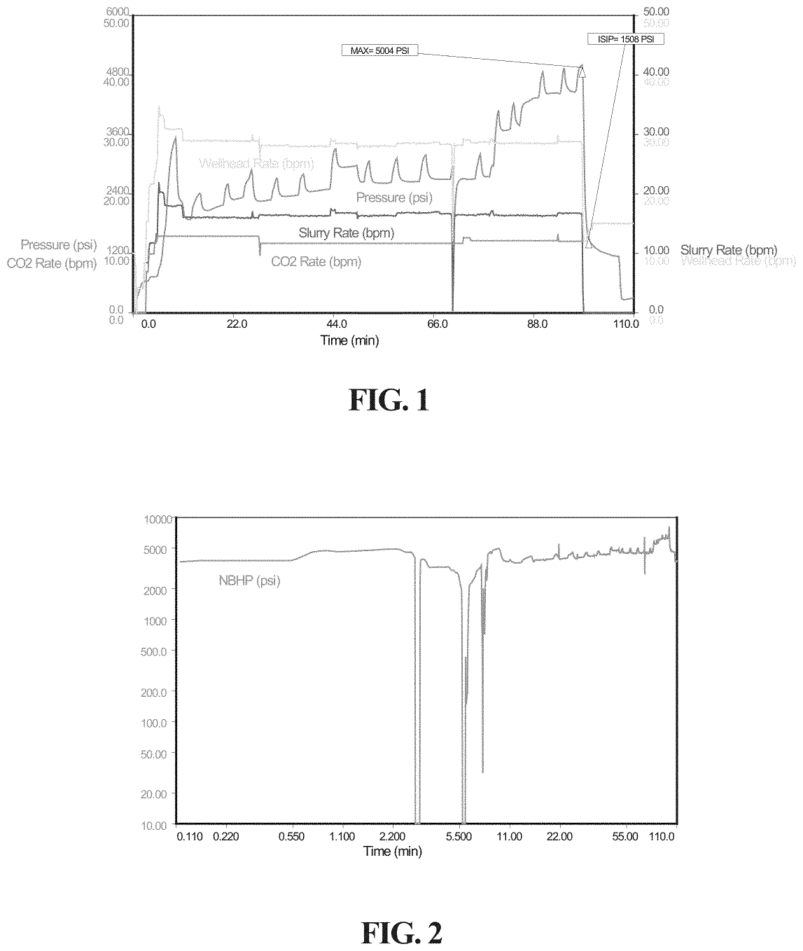

Table 8, shown below, illustrates the executed treatment log for the planned treatment schedule as presented above. FIG. 1 illustrates wellhead rate, pressure, slurry rate, and CO₂ rate during the executed treatment. FIG. 2 illustrates net bottom-hole pressure during the executed treatment.

TABLE 8

| | | | | | | | | Barrels/Linear |
|---|---|---|---|---|---|---|---|---|
| | Depth | OD | Weight | | ID | Volume | | Feet |
| Tubing 1 Length (ft): | | | | | | 0.00 | bbl | 0.00000 |
| Tubing 2 Length (ft): | | | | | | 0.00 | bbl | 0.00000 |
| Casing 1 Length (ft): | 9,717 | 7 | 26.00 | 6.276 | | 371.77 | bbl | 0.03826 |
| Casing 2 Length (ft): | 18,080 | 4 | 11.6 | 3.428 | | 467.28 | bbl | 0.01142 |
| Open Hole Length (ft): | | N/A | N/A | | | 0.00 | bbl | 0.00000 |
| Combined Depth (ft): | | | | | Annular Vol. | 236.40 | bbl | 0.00000 |

| | Depth | Vol. | | | | |
|---|---|---|---|---|---|---|
| Top Perf/Open Hole: | 11,890 | 396.59 | Maximum Pressure: | 5,004 | ISIP: | 1,508 |
| Bottom Perf/Open Hole: | 17,981 | 466.15 | Average Pressure: | 2,773 | 5 min: | 398 |
| Number of Perfs: | 612 | | Max Slurry Rate: | 30 | 10 min: | 388 |
| Perf Size: | 0.41 | | Average Slurry Rate: | 17 | 15 min: | 380 |
| Frac Grad: | 0.58 | | Max CO₂ Rate: | 13 | | |
| Packer Depth: | N/A | | Average CO₂ Rate: | 12 | | |
| | | | Max Wellhead Rate: | 36 | | |
| | | | Average Wellhead Rate | 29 | Fluid to | 2067 |
| | | | | | Recover | |

| STP | Net PSI | Rate | Stage | Total | Comments |
|---|---|---|---|---|---|
| — | | | | | Arrive on Location |
| — | | | | | Operation Safety Meeting |
| — | | | | | Warming up Equipment |
| 9500 | | | | | Test Lines |
| 2500 | | | | | Test Backside Pop-Off |
| — | | | | | Leak on Iron |
| — | | | | | Venting Testing Hoses |
| — | | | | | Opening Wellhead |
| 612 | 0 | 8.0 | 97.0 | 0.0 | Establish Rate Break @ (3,530 psi) |
| 2656 | 0 | 17.9 | 115.0 | 97.0 | Start ClO₂ Treatment Stage 1 |
| 1886 | 985 | 16.1 | 6.0 | 212.0 | Start Spacer/Drop 36 Diverters |
| 2336 | 1049 | 16.0 | 171.0 | 218.0 | Start ClO₂ Treatment Stage 2 |
| 2110 | 814 | 16.0 | 0.0 | 389.0 | Establish Rate on Formation |
| 21487 | 898 | 16.0 | 25.0 | 389.0 | Start Spacer/Drop 36 Diverters |
| 2200 | 931 | 16.0 | 166.0 | 414.0 | Start ClO₂ Treatment Stage 3 |
| 2294 | 928 | 16.0 | 0.0 | 580.0 | ClO₂ Treatment Stage 1 on Formation |
| 2630 | 1212 | 16.0 | 13.0 | 580.0 | Start Spacer/Drop 36 Diverters |
| 2675 | 1335 | 16.0 | 0.0 | 593.0 | Spacer/Drop 36 Diverters on Formation |
| 2695 | 1374 | 16.5 | 0.0 | 593.0 | ClO₂ Treatment Stage 2 on Formation |
| 2800 | 1439 | 16.3 | 166.0 | 593.0 | Start ClO₂ Treatment Stage 4 |
| 23149 | 1058 | 16.0 | 0.0 | 759.0 | Spacer/Drop 36 Diverters on Formation |
| 2315 | 1020 | 16.0 | 0.0 | 759.0 | ClO₂ Treatment Stage 3 on Formation |
| 2253 | 1046 | 16.5 | 0.0 | 759.0 | Spacer/Drop 36 Diverters on Formation |
| 2541 | 1339 | 16.3 | 8.0 | 759.0 | Start Spacer/Drop 36 Diverters |
| 2638 | 1436 | 16.4 | 97.0 | 767.0 | Start ClO₂ Treatment Stage 5 |
| 2420 | 1620 | 16.0 | 6.0 | 864.0 | Start Spacer/Drop 36 Diverters |
| 2611 | 1529 | 16.0 | 97.0 | 870.0 | Start ClO₂ Treatment Stage 6 |
| 2463 | 1336 | 16.0 | 0.0 | 967.0 | ClO₂ Treatment Stage 4 on Formation |
| 2461 | 1339 | 16.0 | 0.0 | 967.0 | Spacer/Drop 36 Diverters on Formation |
| 2475 | 1342 | 16.0 | 0.0 | 967.0 | ClO₂ Treatment Stage 5 on Formation |
| 2605 | 1344 | 16.0 | 0.0 | 967.0 | Spacer/Drop 36 Diverters on Formation |
| 30064 | 1804 | 17.0 | 6.0 | 967.0 | Start Spacer/Drop 36 Diverters |
| 3257 | 1994 | 17.0 | 160.0 | 973.0 | Start ClO₂ Treatment Stage 7 |
| 2629 | 1500 | 16.0 | 10.0 | 1133.0 | Start Spacer/Drop 36 Diverters |
| 2622 | 1485 | 16.0 | 110.0 | 1143.0 | Start ClO₂ Treatment Stage 8 |
| 2617 | 1477 | 16.0 | 0.0 | 1253.0 | ClO₂ Treatment Stage 6 on Formation |
| 3087 | 1948 | 16.0 | 8.0 | 1253.0 | Start Spacer/Drop 36 Diverters |
| 1660 | 1460 | 17.0 | 110.0 | 1261.0 | Start ClO₂ Treatment Stage 9 |
| 2647 | 1443 | 16.0 | 0.0 | 1371.0 | Spacer/Drop 36 Diverters on Formation |
| 2646 | 1447 | 16.0 | 0.0 | 1371.0 | ClO₂ Treatment Stage 7 on Formation |
| 3132 | 1935 | 16.0 | 6.0 | 1371.0 | Start Spacer/Drop 36 Diverters |
| 3188 | 1985 | 16.0 | 0.0 | 1377.0 | Spacer/Drop 36 Diverters on Formation |
| 3188 | 1985 | 16.0 | 103.0 | 1377.0 | Start ClO₂ Treatment Stage 10 |
| 2696 | 1481 | 17.0 | 0.0 | 1480.0 | ClO₂ Treatment Stage 8 on Formation |
| 2978 | 1899 | 10.0 | 6.0 | 1480.0 | Start Spacer/Drop 36 Diverters |
| 2254 | 1084 | 17.0 | 91.0 | 1486.0 | Start ClO₂ Treatment Stage 11 |
| 2694 | 1434 | 16.0 | 0.0 | 1577.0 | Spacer/Drop 36 Diverters on Formation |
| 2695 | 1423 | 16.0 | 0.0 | 1577.0 | ClO₂ Treatment Stage 9 on Formation |
| 3002 | 1800 | 16 | 8.0 | 1577.0 | Start Spacer/Drop 36 Diverters |
| 3202 | 1975 | 16 | 60.0 | 1585.0 | Start ClO₂ Treatment Stage 12 |
| 3925 | 2689 | 16.0 | 0.0 | 1645.0 | Spacer/Drop 36 Diverters on Formation |
| 4069 | 2845 | 16.0 | 0.0 | 1645.0 | ClO₂ Treatment Stage 10 on Formation |
| 3934 | 268 | 16 | 5.0 | 1645.0 | Start Spacer/Drop 36 Diverters |
| 3681 | 2492 | 16 | 60.0 | 1650.0 | Start ClO₂ Treatment Stage 13 |
| 4199 | 2993 | 16 | 5.0 | 1710.0 | Start Spacer/Drop 36 Diverters |
| 4004 | 2863 | 16 | 103.0 | 1715.0 | Start ClO₂ Treatment Stage 14 |
| 4243 | 3050 | 16.0 | 0.0 | 1818.0 | Spacer/Drop 36 Diverters on Formation |
| 4250 | 3049 | 16 | 0.0 | 1818.0 | ClO₂ Treatment Stage 11 on Formation |
| 4809 | 3611 | 16 | 6.0 | 1818.0 | Start Spacer/Drop 36 Diverters |
| 4622 | 3485 | 16 | 84.0 | 1824.0 | Start ClO₂ Treatment Stage 15 |
| 4432 | 3236 | 16 | 0.0 | 1908.0 | Spacer/Drop 36 Diverters on Formation |
| 4433 | 3245 | 16 | 0.0 | 1908.0 | ClO₂ Treatment Stage 12 on Formation |
| 4669 | 3418 | 16 | 5.0 | 1908.0 | Start Spacer/Drop 36 Diverters |
| 4775 | 3519 | 16 | 70.0 | 1913.0 | Start ClO₂ Treatment Stage 16 |
| 7780 | 3256 | 17 | 0.0 | 1983.0 | Spacer/Drop 36 Diverters on Formation |
| 4470 | 3248 | 16 | 0.0 | 1983.0 | ClO₂ Treatment Stage 13 on Formation |
| 3389 | 4243 | 16 | 8.0 | 1983.0 | Start Spacer/Drop 36 Diverters |
| 1831 | 2578 | 14 | 70.0 | 1991.0 | Start ClO₂ Treatment Stage 17 |
| 1410 | 1927 | 14 | 6.0 | 2061.0 | Start Spacer/Drop 36 Diverters |
| 1377 | 1816 | 14 | 98.0 | 2067.0 | Start CO₂ Flush |
| — | | | | | Shutdown |
| 380 | | | | | 5, 10, 15 |
| | | | | | Start Rigging Down |
| | | | | | Leave Location |

Although various embodiments of the present disclosure have been described in the foregoing Detailed Description, it will be understood that the present disclosure is not limited to the embodiments disclosed herein, but is capable of numerous rearrangements, modifications, and substitutions without departing from the spirit of the disclosure as set forth herein.

The term “substantially” is defined as largely but not necessarily wholly what is specified, as understood by a person of ordinary skill in the art. In any disclosed embodiment, the terms “substantially”, “approximately”, “generally”, and “about” may be substituted with “within [a percentage] of” what is specified, where the percentage includes 0.1, 1, 5, and 10 percent.

The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. Those skilled in the art should also realize that such equivalent constructions do not depart from the spirit and scope of the disclosure, and that they may make various changes, substitutions, and alterations herein without departing from the spirit and scope of the disclosure. The scope of the invention should be determined only by the language of the claims that follow. The term “comprising” within the claims is intended to mean “including at least” such that the recited listing of elements in a claim are an open group. The terms “a”, “an”, and other singular terms are intended to include the plural forms thereof unless specifically excluded.

What is claimed is:

1. A method for well stimulation, the method comprising:
pumping a treatment fluid into a well,
wherein the treatment fluid comprises carbon dioxide (CO₂) and a breaker; and
treating at least one of a reservoir and a wellbore of the well with the treatment fluid.

2. The method of claim 1, wherein the breaker is selected from the group consisting of guar breakers, friction reducer breakers, slickwater breakers, oxidative breakers, enzyme breakers, gel breakers, ammonium persulfate, polyacrylamide breakers, or combinations thereof.

3. The method of claim 1, wherein the breaker is a solution.

4. The method of claim 3, wherein the solution comprises stabilized chlorine dioxide (ClO₂).

5. The method of claim 4, wherein the solution has a concentration of 5% v/v of the stabilized ClO₂.

6. The method of claim 4, comprising:
commingling the CO₂ with water; and
forming, as a result of the commingling, carbonic acid.

7. The method of claim 6, comprising activating the stabilized ClO₂ to form activated ClO₂.

8. The method of claim 7, wherein the activated ClO₂ is formed as a result of a lowering of pH in the treatment fluid by the carbonic acid.

9. The method of claim 8, wherein the lowering of pH results in the treatment fluid having a pH between about 4 to about 5.

10. The method of claim 7, wherein the activated ClO₂ is formed at a predetermined depth in the well based, at least in part, on a concentration of the CO₂ and the stabilized ClO₂ in the treatment fluid.

11. The method of claim 1, wherein the breaker is in a range of about 20% to about 75% total volume of the treatment fluid.

12. The method of claim 1, comprising pumping a treated spacer into the well.

13. The method of claim 12, wherein the treated spacer comprises a diverter agent to divert the treatment fluid to a particular zone of interest.

14. The method of claim 1, wherein the treatment fluid comprises a water block removing agent selected from the group consisting of stimulation surfactants, ethoxylated surfactants, sulfonated surfactants, citrus terpenes, alcohols, ionic surfactants, nonionic surfactants, cationic surfactants, anionic surfactants, amphoteric surfactants, flow-back enhancers, emulsifiers, dispersants, oil-wetters, water-wetters, foamers, defoamers, or combinations thereof.

15. The method of claim 14, wherein the water block removing agent is in a range of about 20% to about 75% total volume of the treatment fluid.

16. The method of claim 1, wherein the CO₂ is in a range of about 20% to about 75% total volume of the treatment fluid.

17. The method of claim 1, comprising:
shutting-in the well for a predetermined period of time; and
flowing back the well after the predetermined period of time.

18. The method of claim 1, wherein the treating comprises at least one of mobilizing hydrocarbons in the reservoir, freeing hydrocarbons in the reservoir, lowering surface tension of residual fluids in the reservoir, and removing damage caused by residual material from previous fluids introduced into the well.

19. The method of claim 1, wherein the treatment fluid comprises at least one of clay control agents, surfactants, foaming agents, fluid loss additives, scale reducing agents, corrosion inhibitors, biocides, and pH control additives.

20. A method for well stimulation, the method comprising:
pumping a treatment fluid into a well,
wherein the treatment fluid comprises carbon dioxide (CO₂), stabilized chlorine dioxide (ClO₂), and a water block removing agent selected from the group consisting of stimulation surfactants, ethoxylated surfactants, sulfonated surfactants, citrus terpenes, alcohols, ionic surfactants, nonionic surfactants, cationic surfactants, anionic surfactants, amphoteric surfactants, flow-back enhancers, emulsifiers, dispersants, oil-wetters, water-wetters, foamers, defoamers, or combinations thereof;
commingling the CO₂ with water;
forming, as a result of the commingling, carbonic acid;
lowering pH of the treatment fluid with the carbonic acid;
activating the stabilized ClO₂ to form activated ClO₂,
wherein the activating occurs at a predetermined depth based, at least in part, on a concentration of the CO₂ and the stabilized ClO₂ in the treatment fluid, and
wherein the activated ClO₂ is formed due to a lowering of pH in the treatment fluid by the carbonic acid; and
treating at least one of a reservoir and a wellbore of the well with the treatment fluid.
